(19) United States
(12) Patent Application Publication
(10) Pub. No.: US 2002/0120769 A1
(43) Pub. Date: Aug. 29, 2002

(54) Multicast traffic control protocol pruning in a layer 2 switch

(76) Inventor: Benny Loenstrup Ammitzboell, Vaerlose (DK)

Correspondence Address: Joseph A. Twarowski, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/746,092

(22) Filed: Dec. 21, 2000

(51) Int. Cl. G06F 15/173

(52) U.S. Cl. 709/238

(57) ABSTRACT

Methods and apparatuses for multicast traffic control protocol pruning in a layer 2 network. A layer 2 device such as a switch with a plurality of ports includes a multicast traffic control protocol pruning algorithm executable from the layer 2 device to control multicast traffic in the layer 2 network. The layer 2 device further includes a multicast traffic control protocol querier selection algorithm executable from the layer 2 device to send multicast traffic control protocol queries to a layer 2 network which includes the layer 2 device. The layer 2 device includes the multicast traffic control protocol querier algorithm as part of its multicast traffic control protocol pruning capabilities. A separate multicast router to generate the multicast traffic control protocol queries can be eliminated from the system, thereby decreasing cost and complexity.

### FIELD OF THE INVENTION

The invention relates generally to networked devices. More particularly, the invention relates to registration protocols for multicast traffic and methods for layer 2 control of multicast groups.

### BACKGROUND OF THE INVENTION

Multicasting of network traffic includes communication between a single sender and multiple receivers on the network. Exemplary uses include, but are not limited to, the updating of mobile personnel from a home office, the periodic issuance of online newsletters, and delivery of information to a number of receiving appliances such as televisions, computers and the like.

Registration protocols for multicast traffic are becoming increasingly interesting as IP multicast (IP MC) protocols are being used to broadcast traffic from one or more transmitters to any number of potential receivers. IP multicast protocols operate at layer 3 (network level) and control the forwarding of traffic (i.e. in the direction of present receivers only). At layer 3, a mechanism exists to direct the traffic to the networks where receivers are demanding the traffic. A router is an example of such a layer 3 mechanism. At layer 2 (switch or connection level), however, the traffic is bridged, which may lead to flooding traffic on all ports of the device in question even in a case where just one receiver is present on one port of the device.

The Internet Group Management Protocol (IGMP) is used by IP hosts to report their multicast group memberships to any immediately-neighboring multicast routers. IGMP is a layer 3 protocol, which means that IGMP methods are used to control multicast traffic with network routers. Routers direct multicast traffic to switches having nodes that are intended to receive the multicast traffic. However, as multicast traffic increases additional pruning is desirable at the switch level (layer 2) in order to more efficiently use available switch bandwidth. IGMP has been applied to switches to provide additional pruning, but because IGMP is a layer 3 protocol, such IGMP-based layer 2 pruning is inefficient.

IGMP pruning is a method for layer 2 control of IP multicast group Media Access Control (MAC) addresses. It is a non-standard method based on snooping IGMP query, report and leave messages, and using these to figure out where IP multicast transmitters and receivers are present. It is basically layer 3 protocol information used to control layer 2 forwarding/filtering behavior.

Routers are electronic systems that determine the next network point to which a packet should be forwarded toward the packet's destination. Routers are connected to at least two networks and decide which way to send each information packet based on the router's current understanding of the state of the networks it is connected to. Routers can be combined and can include additional components. A router creates or maintains a table of the available routes and their conditions and uses this information along with distance and cost algorithms to determine the best route for a given packet. Typically, a packet may travel through a number of network points with routers before arriving at its destination.

Switches are network devices that select a path or circuit for sending a unit of data to its next destination. In general, a switch is a simpler and faster mechanism than a router, which requires knowledge about the network and how to determine the route. On larger networks, the trip from one switch point to another in the network is called a hop. Switches can be combined and can include additional components.

Routers and switches usually include a bus or other communication device to communicate information, and a processor coupled to the bus to process the information. Routers and switches can include multiple processors and/or co-processors. Routers and switches can further includes memory coupled to the bus to store information and instructions to be executed by the processor. Memory also can be used to store temporary variables or other intermediate information during execution of instructions by the processor.

Typically, routers and switches include multiple media access controllers (MACs) that are coupled to input ports to receive packets of data from a network. Packets of data received by the MACs are forwarded to the memory. The memory stores packets of data for processing and/or forwarding by router or switch.

Routers and switches can also include multiple MACs coupled to memory to receive packets to be forwarded through corresponding output ports. Packets can be forwarded to other networked devices (e.g., nodes).

In a purely layer 2 network that does not include a router, control of multicast traffic and IGMP pruning at the switch level can be accomplished in order to more efficiently use available switch bandwidth.

### BRIEF DESCRIPTION OF THE DRAWINGS

The invention is illustrated by way of example, and not limitation, in the figures of the accompanying drawings in which:

FIG. 1 is a schematic diagram of a network including a multicast router using IGMP;

FIG. 2 is a schematic diagram of a network including a multicast router illustrating the use of IGMP pruning with a layer 2 switch;

FIG. 3 is a schematic diagram of a pure layer 2 network illustrating the use of IGMP pruning with a layer 2 switch;

FIG. 4 is an example of a state transition diagram for a router; and

FIG. 5 is a flowchart illustrating an embodiment of a method of the present invention.

### DETAILED DESCRIPTION

Embodiments of the invention described herein provide methods and apparatuses for multicast traffic control protocol pruning in a layer 2 network. The methods and apparatuses described herein use registration protocols for multicast traffic to control multicast groups in a pure layer 2 network. In one embodiment, a layer 2 device such as a switch with a plurality of ports includes a multicast traffic control protocol such as Internet Group Management Protocol (IGMP). An IGMP querier selection algorithm is executable from the layer 2 device to send IGMP queries to a layer 2 network which includes the layer 2 device. The layer 2 device further includes an IGMP pruning algorithm executable from the layer 2 device to control Internet protocol (IP) multicast traffic in the layer 2 network.

The IGMP querier selection algorithm from the IGMP protocol is conventionally located or executed from an IP multicast router. The various embodiments of the present invention implement the IGMP querier algorithm in a layer 2 device as part of its IGMP pruning capabilities. A separate IP multicast router to generate the IGMP queries can be eliminated from the system, thereby decreasing cost and complexity.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description which follows are presented in terms of algorithms and symbolic representations of operations on data within a computer memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise apparent from the following discussion throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatuses for performing the operations herein. These apparatuses may be specially constructed for the required purposes, or may comprise a general-purpose computer selectively activated or reconfigured by a computer program stored in the computer. Such a computer program may be stored in a machine-readable or accessible storage medium, such as, but not limited to, any type of magnetic or other disk storage media including floppy disks, optical storage media, CD-ROMs, and magnetic-optical disks, read-only memories (ROMs), random access memories (RAMs), EPROMs, EEPROMs, magnetic or optical cards, flash memory devices, electrical, optical, acoustical or other form of propagated signals (e.g., carrier waves, infrared signals, digital signals, etc.); etc. or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### The Internet Group Management Protocol (IGMP)

The following is a brief description of an embodiment of the IGMP. It should be noted that timer and counter names appear in square brackets. The term “interface” is sometimes used herein to mean “the primary interface on an attached network”; if a router has multiple physical interfaces on a single network this protocol need only run on one of them. Hosts, on the other hand, need to perform their actions on all interfaces that have memberships associated with them.

Multicast routers use IGMP to learn which groups have members on each of their attached physical networks. A multicast router keeps a list of multicast group memberships for each attached network, and a timer for each membership. “Multicast group memberships” means the presence of at least one member of a multicast group on a given attached network, not a list of all of the members.

With respect to each of its attached networks, a multicast router may assume one of two roles: Querier or Non-Querier. There is normally only one Querier per physical network. All multicast routers start up as a Querier on each attached network. If a multicast router hears a Query message from a router with a lower IP address, it MUST become a Non-Querier on that network. If a router has not heard a Query message from another router for [Other Querier Present Interval], it resumes the role of Querier. Routers periodically [Query Interval] send a General Query on each attached network for which this router is the Querier, to solicit membership information. On startup, a router SHOULD send [Startup Query Count] General Queries spaced closely together [Startup Query Interval] in order to quickly and reliably determine membership information. A General Query is addressed to the all-systems multicast group (224.0.0.1), has a Group Address field of 0, and has a Max Response Time of [Interval].

When a host receives a General Query, it sets delay timers for each group (excluding the all-systems group) of which it is a member on the interface from which it received the query. Each timer is set to a different random value, using the highest clock granularity available on the host, selected from the range (0, Max Response Time] with Max Response Time as specified in the Query packet. When a host receives a Group-Specific Query, it sets a delay timer to a random value selected from the range (0, Max Response Time] as above for the group being queried if it is a member on the interface from which it received the query. If a timer for the group is already running, it is reset to the random value only if the requested Max Response Time is less than the remaining value of the running timer. When a group's timer expires, the host multicasts a Version 2 Membership Report to the group, with IP TTL of 1. If the host receives another host's Report (version 1 or 2) while it has a timer running, it stops its timer for the specified group and does not send a Report, in order to suppress duplicate Reports.

When a router receives a Report, it adds the group being reported to the list of multicast group memberships on the network on which it received the Report and sets the timer for the membership to the [Group Membership Interval]. Repeated Reports refresh the timer. If no Reports are received for a particular group before this timer has expired, the router assumes that the group has no local members and that it need not forward remotely-originated multicasts for that group onto the attached network.

When a host joins a multicast group, it should immediately transmit an unsolicited Version 2 Membership Report for that group, in case it is the first member of that group on the network. To cover the possibility of the initial Membership Report being lost or damaged, it is recommended that it be repeated once or twice after short delays [Unsolicited Report Interval]. (A simple way to accomplish this is to send the initial Version 2 Membership Report and then act as if a Group-Specific Query was received for that group, and set a timer appropriately).

When a host leaves a multicast group, if it was the last host to reply to a Query with a Membership Report for that group, it SHOULD send a Leave Group message to the all-routers multicast group (224.0.0.2). If it was not the last host to reply to a Query, it MAY send nothing as there must be another member on the subnet. This is an optimization to reduce traffic; a host without sufficient storage to remember whether or not it was the last host to reply MAY always send a Leave Group message when it leaves a group. Routers SHOULD accept a Leave Group message addressed to the group being left, in order to accommodate implementations of an earlier version of this standard. Leave Group messages are addressed to the all-routers group because other group members have no need to know that a host has left the group, but it does no harm to address the message to the group.

When a Querier receives a Leave Group message for a group that has group members on the reception interface, it sends [Count] Group-Specific Queries every [Last Member Query Interval] to the group being left. These Group-Specific Queries have their Max Response time set to [Last Member Query Interval]. If no Reports are received after the response time of the last query expires, the routers assume that the group has no local members, as above. Any Querier to non-Querier transition is ignored during this time; the same router keeps sending the Group-Specific Queries.

Non-Queriers MUST ignore Leave Group messages, and Queriers SHOULD ignore Leave Group messages for which there are no group members on the reception interface.

When a non-Querier receives a Group-Specific Query message, if its existing group membership timer is greater than [Last Member Query Count] times the Max Response Time specified in the message, it sets its group membership timer to that value.

### Multicast Networks

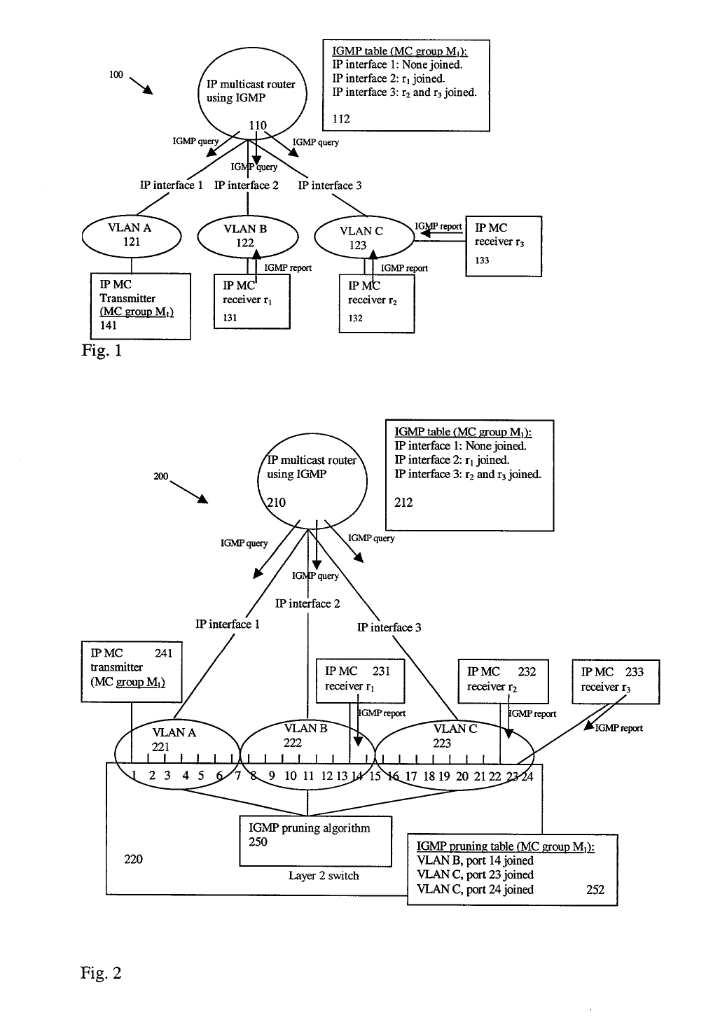

An embodiment of a basic network 100 is shown in FIG. 1. Network 100 includes an IP multicast router 110 connected through IP interfaces to VLANs 121, 122, and 123. IP multicast receiver 131 is connected to VLAN A 121. IP multicast receivers 132 and 133 are both connected to VLAN C 123. IP multicast transmitter 141 is connected to VLAN A 121. Receivers 131 can be referred to as hosts.

An IGMP table 112 is created on router 110. IGMP table 112 provides information about multicast group M1 such as which interfaces with the various VLANs have hosts or receivers joined to them. The router determines whether one or more attached switches have nodes that have registered to receive multicast traffic from transmitting device 141. If so, the router forwards the appropriate multicast traffic to the switch. Otherwise, multicast traffic is not forwarded. For example, if receivers 131, 132, and 133 are registered to receive multicast traffic from transmitting device 141, router 110 forwards the multicast traffic to the appropriate VLANs.

Hosts that wish to join an IP multicast group do so by sending an IGMP report message for the group(s) they wish to receive. An IP multicast router sends out periodic IGMP queries in the VLANs A, B and C. For each query sent, a receiving host must respond with an IGMP report message if it wants to keep receiving IP multicast. In case a receiving host no longer wants to receive IP multicast, it can send an IGMP leave message. Note that if a host does not transmit a leave (e.g. because it was powered off) the periodic IGMP query/IGMP report system will ensure that the registration is removed.

FIG. 2 shows an example of a network 200 using IGMP pruning. A layer 2 device 220, such as a switch, controls to which ports (numbered 1 through 24) IP multicast traffic is forwarded by snooping the IGMP query, report and leave messages. The query message is used to start an internal timer and the IGMP report and leave message is used to maintain the IGMP pruning table (in which is stored information about which host(s) is/are joined on which port(s)).

In FIG. 2, IP multicast router 210 is connected through several interfaces to VLAN A 221, VLAN B 222, and VLAN C 223. IP multicast receiver 231 is coupled to VLAN B 222, and IP multicasts receivers 232 and 233 are coupled to VLAN C 223. IP multicast transmitter 241 is coupled to VLAN A 221. An example of an IP multicast transmitter is a server. Such a transmitter transmits traffic on a multicast group.

An IGMP table 212 stores information about which interfaces between the router 210 and the various and VLANs have receivers joined. The layer 2 device 220 includes an IGMP pruning algorithm 250, and an IGMP pruning table 252 is stored on the layer 2 device 220. In the exemplary embodiment of FIG. 2, the layer 2 device 220 is a switch.

The above described method for implementing IGMP pruning works well for networks where IP multicast routers are used to route between VLANs. However, it does not work well for networks where customers want to use the IGMP pruning in a pure layer 2 network—e.g. where transmitters and receivers are located on the same VLAN. In such a network, there is no IP multicast router generating the periodic IGMP queries, and without these the hosts will not send periodic IGMP reports. In such an environment, IGMP pruning will not work.

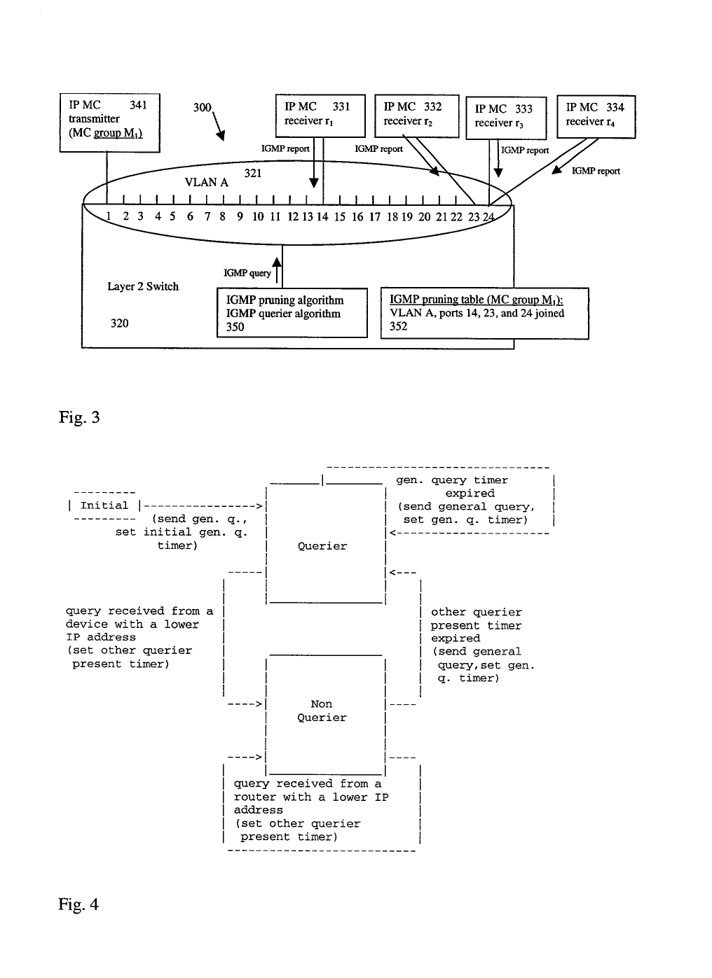

To eliminate an external IP multicast router, the full layer 3 IGMP stack could be implemented in the layer 2 device. However, implementing a full IGMP protocol in a layer 2 device may not be possible due to hardware limitations. By embedding the only IGMP querier functionality in the layer 2 switch as shown on the FIG. 3, the layer 2 switch is able to use IGMP pruning without the need for an external IP multicast router or a full IGMP stack on the layer 2 switch.

FIG. 3 shows an example of a network 300 that includes IGMP pruning capability as well as the IGMP querier algorithm on the layer 2 device 320. The layer 2 device 320 controls to which ports (numbered 1 through 24) IP multicast traffic is forwarded by snooping the IGMP query, report and leave messages. The query message is used to start an internal timer and the IGMP report and leave message is used to maintain the IGMP pruning table (in which is stored information about which host(s) is/are joined on which port(s)).

In FIG. 3, the network 300 does not include an IP multicast router. Only one VLAN A 321 is provided in this embodiment, however, more than one VLAN could be provided on the network 300. IP multicast receiver 331 is coupled to port 14 on the switch 320, receiver 332 is coupled to port 23 and receivers 333 and 334 are both coupled to port 24. Any combination of receivers (as well as transmitters) and ports can be provided. For instance, there can be more than one receiver on one port, as shown in FIG. 3, or a port could be connected to a hub (such as a repeater) and a plurality of receivers on the hub.

IP multicast transmitter 341 is coupled to VLAN A 321 at port 1 on the switch 320. The transmitter 341 sends traffic to the VLAN.

An IGMP pruning table 352 stores information about which ports on VLAN A have receivers joined. The IGMP pruning table 252 is stored on the layer 2 device 320. The layer 2 device 320 includes an IGMP pruning algorithm together with an IGMP querier algorithm 350.

To ensure that the layer 2 switch is able to operate also in a network in which IP multicast routers are present, it is necessary that the IGMP querier algorithm embedded in the layer 2 switch follows the suggested specification for IGMP. The IGMP querier algorithm is an election scheme which ensures that there is always one device per VLAN that is transmitting IGMP general queries with a fixed time interval between. IGMP pruning will not work in a VLAN unless there is an active querier. FIG. 4 shows an example of a state transition diagram for a router.

Note that the layer 2 switch can either use its host IP address as source IP address in the IGMP queries that it transmits in all VLANs—or an IP address can be assigned per VLAN for this purpose (if the VLANs are different IP networks).

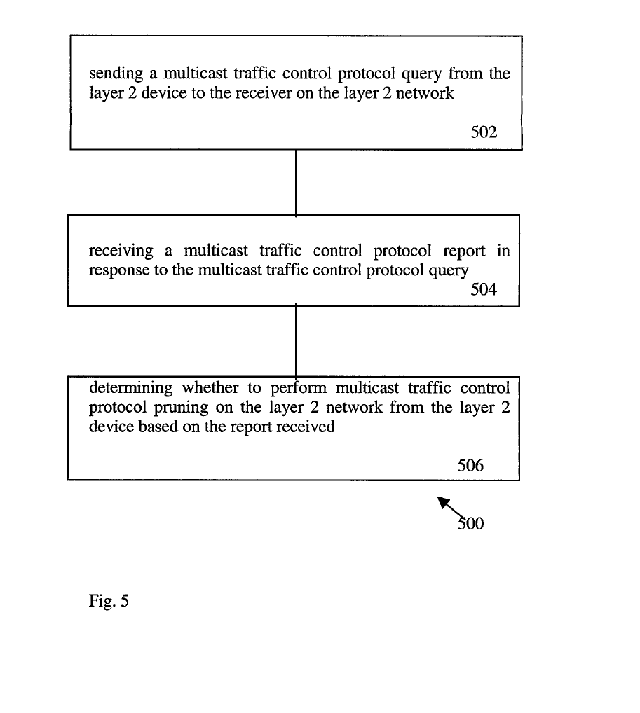

The particular methods of the invention can described with reference to the flowchart shown in FIG. 5 in which one embodiment of the method 500 constitutes processes and operations represented by block 502 until 506. Embodiments of the method may constitute computer programs made up of computer-executable instructions illustrated as blocks 502 until 506 in FIG. 5.

Describing the methods by reference to a flowchart enables one skilled in the art to develop such programs including such instructions to carry out the methods on suitably configured computers (the processor of the computer executing the instructions from computer-readable media). If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or a produce a result.

FIG. 5 shows a flowchart of an exemplary method 500 of the present invention in which the various blocks represent operations or procedures to perform the method 500. Method 500 includes the operation of controlling multicast traffic (such as Internet protocol traffic) in a layer 2 network. The layer 2 network includes a plurality of devices associated with the network. The plurality of devices may include a transmitter, a receiver, and a layer 2 device having a plurality of ports to which the multicast traffic is selectively forwarded. The transmitter and the receiver can be coupled to one or more of the ports.

Block 502 shows the operation of sending a multicast traffic control protocol query from the layer 2 device to the receiver on the layer 2 network. An example of a multicast traffic control protocol is the Internet Group Management Protocol (IGMP) Block 504 shows the operation of receiving a multicast traffic control protocol report in response to the multicast traffic control protocol query. Block 506 shows the operation of determining whether to perform a multicast traffic control protocol pruning on the layer 2 network from the layer 2 device based on the report received.

The following lists pseudo-code to implement the invention. In one embodiment, the code includes 7 parts (1-3 provided merely for clarity, 4-7 contains actual algorithm that may be embedded in a layer 2 switch, for example):

1) Various defines and variables used.

2) Function to send IGMP queries—IgmpSendQuery (incomplete since this is platform dependent).

3) Function which updates the timestamps in the IGMP pruning table—IgmpUpdateTimeStamp (incomplete since this is part of the IGMP pruning algorithm).

4) Function to be called at startup to initialize the querier algorithm—QuerierStartup.

5) Function which must be called periodically—IpruTimeTick.

6) Function to handle reception of IGMP queries (e.g. from external IP multicast routers)—HandleIgmpQueryReceived.

7) Function to handle reception of IGMP leaves—HandleIgmpLeaveReceived (incomplete—IGMP pruning stuff left out).

The following pseudo-code describes one embodiment of the first three functions outlined above.

/ *********************************************************************

| | | | |
|---|---|---|---|
| * | Abstract: | RFC2236 | defaults |

********************************************************************* /

| | | | |
|---|---|---|---|
| #define | IGMP_ROBUSTNESS_VAR | 2 | |
| *define | IGMP_QUERY_INTERVAL | 125 | /* seconds */ |
| #define | IGMP_QUERY_RESPONSE_INTERVAL | 10 | /* second */ |

| | | |
|---|---|---|
| #define | IGMP_OTHER_QUERIER_PRESENT_INTERVAL | (IGMP_ROBUSTNESS_VAR * \ |

IGMP_QUERY_INTERVAL + \

| IGMP_QUERY_RESPONSE_INTERVAL/2) | | | |
|---|---|---|---|
| #define | IGMP_STARTUP_QUERY_INTERVAL | (IGMP_QUERY_INTERVAL / 4) | |
| #define | IGMP_STARTUP_QUERY_COUNT | IGMP_ROBUSTNESS_VAR | |
| #define | IGMP_LAST_MEMBER_QUERY_INTERVAL | 1 | /* second */ |

| | | |
|---|---|---|
| #define | IGMP_LAST_MEMBER_QUERY_COUNT | IGMP_ROBUSTNESS_VAR |

/ *********************************************************************
* Abstract: IGMP pruning timetick value (suggested value)
********************************************************************* /

| | | | |
|---|---|---|---|
| #define | IGMP_TIMETICK_VALUE | 1 | /* seconds */ |

/ *********************************************************************
* Abstract: Configuration parameters (read from parameter block)
********************************************************************* /

| | |
|---|---|
| BOOL | ipruGlobalPruningOn; |
| BOOL | ipruAllowAsQuerier; |
| BOOL | ipruPruningOn[PORT_MAX_COMPRESSED_PORTS]; |
| UINT16 | ipruTimerValue; |

/ *********************************************************************
* Abstract: Protocol state (querier/non-querier state per VLAN)
********************************************************************* /

| | |
|---|---|
| BOOL | ipruIsQuerier[MAX_VLANS]; |

/ *********************************************************************
* Abstract: Protocol timers
********************************************************************* /

| | |
|---|---|
| INT16 | ipruOtherQuerierTimer[MAX_VLANS]; |
| INT16 | ipruQueryTimer[MAX_VLANS]; |
| INT16 | ipruTimer[MAX_VLANS]; |

/ *********************************************************************

| | |
|---|---|
| * Abstract: | The maximum number of outstanding specific queries |
| * | (suggested value) |

********************************************************************* /

| | |
|---|---|
| #define | IPRU_MAX_SPEC_QUERIES_OUTSTANDING MAX_VLANS / 4 |

/ *********************************************************************

| | |
|---|---|
| * Abstract: | Structure used for outstanding specific queries that must |
| * | be sent after one second. |

********************************************************************* /
typedef struct t_ipruSpecQueryMsg_
{

| | | |
|---|---|---|
| UINT32 | timerValue; | /* Timer value */ |
| UINT32 | groupAddress; | /* group address to query */ |
| UINT16 | vlanId; | /* vlan Id to send query in */ |
| BYTE | spare[2]; | /* spare */ |

| | |
|---|---|
| } | t_ipruSpecQueryMsg; |

| | |
|---|---|
| static | t_ipruSpecQueryMsg |

ipruSpecQueryMsg[IPRU_MAX_SPEC_QUERIES_OUTSTANDING];
/ *********************************************************************
* Abstract: Send an IGMP general query
********************************************************************* /
static void IgmpSendQuery(UINT16 vlanId, UINT32 groupAddress)
{

/* send an IGMP query in VLAN vlanId using groupAddress */
/* if groupAddress is zero, send a general query */

}
static void IgmpUpdateTimeStamp(UINT16 vlanId)
{

/* Update timestamp of IGMP registrations in VLAN vlanId */
/* If an IGMP registration has not been kept alive, delete */
/* the registration */

}

The following pseudo-code describes one embodiment of the fourth function outlined above.

/ *********************************************************************
* Abstract: Function to be called at startup
********************************************************************* /
static void QuerierStartup(void)
{

UINT16 vlanId;
/*On startup, a

router SHOULD send [Startup Query Count] General Queries spaced
closely together [Startup Query Interval] in order to quickly and
reliably determine membership information. A General Query is
addressed to the all-systems multicast group (224.0.0.1), has a

Group

Address field of 0, and has a Max Response Time of [Query Response
Interval].*/

/* [Startup Query Count] is fixed at 2 (hardcoded) */
for (vlanId: all VLANs)
{

/* Startup, we must assume that we are the querier: */
ipruIsQuerier[vlanId] = TRUE;
/* Send general query if VLAN is active: */
if (vlanId is active)

IgmpSendQuery(vlanId, 0);

/* No other querier (yet) that we must wait for: */
ipruOtherQuerierTimer[vlanId] = 0;
/* Send next general query after startup interval: */
/* NOTE that this hardcodes the [Startup Query Count] */
ipruQueryTimer[vlanId] = IGMP_STARTUP_QUERY_INTERVAL;
/* Set up the pruning timer: */
ipruTimer[vlanId] = ipruTimerValue;

}

}

The following pseudo-code describes one embodiment of the fifth function outlined above.

/ *********************************************************************
* Abstract: Function to be called every IGMP_TIMETICK_VALUE seconds
********************************************************************* /
static void IpruTimeTick(void)
{

UINT16 vlanId, i;
for (vlanId: all VLANs)
{

| | |
|---|---|
| if (ipruAllowAsQuerier) | /* global configuration parameter */ |
| { | |

if (ipruIsQuerier[vlanId])
{ /* we are querier: */

ipruQueryTimer[vlanId] −= IGMP_TIMETICK_VALUE;

if (ipruQueryTimer[vlanId] <= 0)
{

/* it's time to send an IGMP general query */
IgmpSendQuery(vlanId, 0);
/* Restart query timer: */
ipruQueryTimer[vic] += IGMP_QUERY_INTERVAL;

}
else
{

/* check for any specific queries outstanding: */
for (i = 0; i < IPRU_MAX_SPEC_QUERIES_OUTSTANDING; i++)

if (ipruSpecQueryMsg[i].vlanId == vlanId)
{

ipruSpecQueryMsg[i].timerValue −= IGMP_TIMETICK_VALUE;
if (ipruSpecQueryMsg[i].timerValue <= 0)
{

IgmpSendQuery(ipruSpecQueryMsg[i].vlanId,

ipruSpecQueryMsg[i].groupAddress);

ipruSpecQueryMsg[i].vlanId = 0;

}

}

}

}
else
{ /* we are non-querier: */

ipruOtherQuerierTimer[vlanId] −= IGMP_TIMETICK_VALUE;
if (ipruOtherQuerierTimer[vlanId] <= 0)
{

/* Become querier for this VLAN: */
ipruIsQuerier[vlanId] = TRUE;
ipruQueryTimer[vlanId] = IGMP_QUERY_INTERVAL;
IgmpSendQuery(vlanId, 0);

}

}

}
ipruTimer[vlanId] −= IGMP_TIMETICK_VALUE;
if (ipruTimer[vlanId] <= 0)
{

/* Pruning timer has expired */
/* Time out any registration that has not been kept alive: */
IgmpUpdateTimeStamp(vlanId);
/* (re-)start pruning timer: */
ipruTimer[vlanId] = ipruTimerValue;

}

}

}

The following pseudo-code describes one embodiment of the sixth function outlined above.

/ *********************************************************************

| | |
|---|---|
| * Abstract: | Function which handles reception of an IGMP query |
| * Parameters: | ipSource: Source IP address from IGMP query packet |
| | vlanId: VLAN that this IGMP query packet was received on |

********************************************************************* /
static void HandleIgmpQueryReceived(UINT32 ipSource, UINT16 vlanId)
{

/* Become non-querier if 1) Allowed by config. AND */
/* 2) IP source in pkt is less than our IP AND */
/* 3) We are the querier in this VLAN AND (later) */
/* 4) No specific queries are outstanding */
if (ipruAllowAsQuerier &&

ipSource < IpAddr(vlanId) &&
ipruIsQuerier[vlanId])

{

UINT16 i;
BOOL found = FALSE;
/* Check if any specific queries are outstanding */
/* (RFC2236: “Any Querier to non-Querier transition is ignored */
/* during this time; the same router keeps sending the */
/* Group-Specific Queries.” */
for (i = 0; i < IPRU_MAX_SPEC_QUERIES_OUTSTANDING; i++)

if (ipruSpecQueryMsg[i].vlanId == vlanId)
{

found = TRUE;
break;

}

if (!found)

/* Become non-querier for this VLAN: */
ipruIsQuerier[vlanId] = FALSE;

}
if (!ipruIsQuerier[vlanId] &&

ipSource < IpAddr(vlanId))

/* (re)start other querier present timer: */
ipruOtherQuerierTimer[vlanId]

IGMP_OTHER_QUERIER_PRESENT_INTERVAL;
}

The following pseudo-code describes one embodiment of the seventh function outlined above.

/ *********************************************************************

| | |
|---|---|
| * Abstract: | Function which handles reception of an IGMP leave |
| * Parameters: | portNo: Port that this IGMP leave packet was received on |
| * | vlanId: VLAN that this IGMP leave packet was received on |
| * | igmpGroupAddr: Group address from IGMP leave packet |

********************************************************************* /
static void HandleIgmpLeaveReceived (UINT16 portNo, UINT16 vlanId,

UINT32 igmpGroupAddr)

{

if (ipruPruningOn[portNo])
{

if (ipruIsQuerier[vlanId])
{
/* Must send out two specific queries with 1 sec space */
/* Send the first now: */
IgmpSendQuery(vlanId, igmpGroupAddr);
/* Set up timer for the next: */
for (i = 0; i < IPRU_MAX_SPEC_QUERIES_OUTSTANDING; i++)

if (ipruSpecQueryMsg[i].vlanId == 0)
{ /* found a free entry, use it: */

ipruSpecQueryMsg[i].timerValue

IGMP_LAST_MEMBER_QUERY_INTERVAL;

ipruSpecQueryMsg[i].vlanId = vlanId;
ipruSpecQueryMsg[i].groupAddress = igmpGroupAddr;
break;

}

}
/* do IGMP pruning stuff - mark igmpGroupAddr on vlanId and portNo

*/

/* as being left.. */

}

}

IGMP pruning can be implemented in a layer 2 switch without requiring an external IP multicast router. This allows customers to use IGMP pruning in a pure layer 2 environment. By implementing the standard IGMP querier/non-querier selection algorithm, the layer 2 switch will be fully able to operate in an environment with IP multicast routers using IGMP. A customer can buy a layer 2 switch and enable the IGMP pruning. Later the customer may buy IP multicast routers—and the IGMP pruning in the layer 2 switch still works.

What is claimed is:

1. A method comprising:
controlling multicast traffic in a layer 2 network, the layer 2 network including a plurality of devices associated with the network, the plurality of devices including a transmitter, a receiver, and a layer 2 device, the transmitter and the receiver coupled to the layer 2 device, wherein controlling the multicast traffic includes
sending a multicast traffic control protocol query from the layer 2 device to the receiver on the layer 2 network;
receiving a multicast traffic control protocol report in response to the multicast traffic control protocol query; and
determining whether to perform multicast traffic control protocol pruning on the layer 2 network from the layer 2 device based on the report received.

2. The method of claim 1 wherein the layer 2 device has a plurality of ports to which the multicast traffic is selectively forwarded, wherein the transmitter and the receiver are joined to one or more of the ports, and wherein determining whether to perform multicast traffic control protocol pruning on the layer 2 network from the layer 2 device based on the report received includes maintaining a multicast traffic control protocol pruning table to store information regarding which ports are joined.

3. The method of claim 1 further comprising generating periodic multicast traffic control protocol queries, and wherein sending a multicast traffic control protocol query from the layer 2 device to the receiver on the layer 2 network further includes sending at least one of the periodic queries.

4. The method of claim 1 further comprising ensuring that at least one device on the layer 2 network is sending the multicast traffic control protocol query at selected time intervals.

5. The method of claim 4 wherein ensuring that at least one device on the layer 2 network is sending the multicast traffic control protocol query at selected time intervals includes executing a multicast traffic control protocol querier algorithm.

6. An article of manufacture comprising a machine accessible medium providing a plurality of machine readable instructions that, when executed by a machine, cause the machine to perform operations comprising:
controlling multicast traffic in a layer 2 network, the layer 2 network including a plurality of devices associated with the network, the plurality of devices including a transmitter, a receiver, and a layer 2 device, the transmitter and the receiver coupled to the layer 2 device, wherein controlling the multicast traffic includes
sending a multicast traffic control protocol query from the layer 2 device to the receiver on the layer 2 network;
receiving a multicast traffic control protocol report in response to the multicast traffic control protocol query; and
determining whether to perform multicast traffic control protocol pruning on the layer 2 network from the layer 2 device based on the report received.

7. The article of manufacture of claim 6 wherein the layer 2 device has a plurality of ports to which the multicast traffic is selectively forwarded, wherein the transmitter and the receiver are joined to one or more of the ports, and wherein determining whether to perform multicast traffic control protocol pruning on the layer 2 network from the layer 2 device based on the report received includes maintaining a multicast traffic control protocol pruning table to store information regarding which ports are joined.

8. The article of manufacture of claim 6 further comprising generating periodic multicast traffic control protocol queries, and wherein sending a multicast traffic control protocol query from the layer 2 device to the receiver on the layer 2 network further includes sending at least one of the periodic queries.

9. The article of manufacture of claim 6 further comprising ensuring that at least one device on the layer 2 network is sending the multicast traffic control protocol query at selected time intervals.

10. The article of manufacture of claim 9 wherein ensuring that at least one device on the layer 2 network is sending the multicast traffic control protocol query at selected time intervals includes executing a multicast traffic control protocol querier algorithm.

11. A method comprising:
controlling multicast traffic in a layer 2 network, the layer 2 network including a plurality of devices associated with the network, the plurality of devices including a transmitter, a receiver, and a layer 2 device, the transmitter and the receiver coupled to one or more of the ports, wherein controlling the multicast traffic includes
sending an Internet Group Management Protocol (IGMP) query from the layer 2 device to the receiver on the layer 2 network;
receiving an IGMP report in response to the IGMP query; and
determining whether to perform IGMP pruning on the layer 2 network from the layer 2 device based on the report received.

12. The method of claim 11 wherein the layer 2 device has a plurality of ports to which the multicast traffic is selectively forwarded, wherein the transmitter and the receiver are joined to one or more of the ports, and wherein determining whether to perform IGMP pruning on the layer 2 network from the layer 2 device based on the report received includes maintaining an IGMP pruning table to store information regarding which ports are joined.

13. The method of claim 11 further comprising generating periodic IGMP queries, and wherein sending an Internet Group Management Protocol (IGMP) query from the layer 2 device to the receiver on the layer 2 network further includes sending at least one of the periodic queries.

14. The method of claim 11 further comprising ensuring that at least one device on the layer 2 network is sending the IGMP queries at selected time intervals.

15. The method of claim 14 wherein ensuring that at least one device on the layer 2 network is sending the IGMP queries at selected time intervals includes executing an IGMP querier algorithm.

16. An apparatus comprising:
a layer 2 device;
a multicast traffic control protocol querier algorithm executable from the layer 2 device to send multicast traffic control protocol queries to a layer 2 network which includes the layer 2 device; and
a multicast traffic control protocol pruning algorithm executable from the layer 2 device to control multicast traffic in the layer 2 network.

17. The apparatus of claim 16 wherein the layer 2 device includes a plurality of ports.

18. The apparatus of claim 16 wherein the layer 2 device includes a switch.

19. The apparatus of claim 16 wherein the layer 2 network comprises a Virtual Local Area Network (VLAN).

20. The apparatus of claim 16 wherein the layer 2 device includes a plurality of ports and a multicast traffic control protocol pruning table to determine which ports are joined.

21. The apparatus of claim 16 wherein the multicast traffic control protocol is an Internet Group Management Protocol (IGMP).

22. The apparatus of claim 21 wherein the layer 2 device includes a plurality of ports.

23. The apparatus of claim 21 wherein the layer 2 device includes a switch.

24. The apparatus of claim 21 wherein the layer 2 network comprises a Virtual Local Area Network (VLAN).

25. The apparatus of claim 21 wherein the layer 2 device includes a plurality of ports and an IGMP pruning table to determine which ports are joined.

26. An apparatus comprising:
a layer 2 device;
means for sending multicast traffic control protocol queries to a layer 2 network which includes the layer 2 device, the means for sending multicast traffic control protocol queries being executable from the layer 2 device; and
means for controlling multicast traffic in the layer 2 network, the means for controlling multicast traffic being executable from the layer 2 device.

27. The apparatus of claim 26 wherein the layer 2 device includes a plurality of ports.

28. The apparatus of claim 26 wherein the layer 2 device includes a switch.

29. The apparatus of claim 26 wherein the layer 2 network comprises a Virtual Local Area Network (VLAN).

30. The apparatus of claim 26 wherein the layer 2 device includes a plurality of ports and means for determining which ports are joined.
